(19) United States
(12) Patent Application Publication
(10) Pub. No.: US 2015/0335037 A1
(43) Pub. Date: Nov. 26, 2015

(54) METHOD AND SYSTEM FOR USE OF HYDROGEN PEROXIDE AND ULTRAVIOLET LIGHT FOR EGG DISINFECTION AND SANITIZATION

(71) Applicant: The Texas A&M University System, College Station, TX (US)

(72) Inventors: Craig Daniel COUFAL, College Station, TX (US); Steven GOTTSELIG, Houston, TX (US); Kristy WOODRING, Dayton, TX (US)

(73) Assignee: The Texas A&M University System, College Station, TX (US)

(21) Appl. No.: 14/410,483

(22) PCT Filed: Jun. 27, 2013
(86) PCT No.: PCT/US13/48146

§ 371 Date: Dec. 22, 2014

Related U.S. Application Data
(60) Provisional application No. 61/665,609, filed on Jun. 28, 2012.

(51) Int. Cl. A23B 5/015; A23B 5/14; A23B 5/18; A23B 5/20; A23B 5/12

(52) U.S. Cl. CPC A23B 5/015; A23B 5/20; A23B 5/12; A23B 5/18; A23B 5/14; A23V 2002/00

(57) ABSTRACT

In one aspect, the present invention relates to a method of disinfecting an eggshell surface. In various embodiments, the method may include wetting the eggshell surface with a disinfecting agent and exposing the eggshell surface to ultraviolet light after wetting with the disinfecting agent occurs. The combination of wetting the eggshell surface with the disinfecting agent and exposing the eggshell surface to ultraviolet light reduces a number of microbes on the eggshell surface.

### CROSS-REFERENCE TO RELATED APPLICATIONS

This application claims priority to, and incorporates by reference the entire disclosure of, U.S. Provisional Patent Application No. 61/665,609, filed Jun. 28, 2012.

### BACKGROUND

1. Field of the Invention

The present application relates generally to methods and systems for sanitizing eggs and more specifically, but not by way of limitation, to methods and systems for sanitizing eggs utilizing hydrogen peroxide in combination with exposure to ultraviolet light.

2. History of the Related Art

Disinfection of eggshells plays an important role in reducing transmission of pathogens such as Salmonella during egg incubation and hatching. Disinfection of eggshells is also important in the productions of eggs for human consumption (known as “table eggs”) as well as the production of eggs for vaccine production. Facility hygiene is an important factor for reducing egg and equipment contamination. In commercial operations, eggshell microbial growth results in cross-contamination of adjacent eggs as well as cross-contamination of egg incubation and hatching equipment. Further, egg incubation and hatching equipment often maintain temperatures and humidity levels that allow microorganisms to proliferate. Microorganisms found on surfaces of eggshells can be distributed throughout a commercial facility, potentially affecting other eggs and chicks. In general, lack of eggshell disinfection has been shown to negatively impact embryo mortality and chick quality resulting in increased production costs. Additional research regarding eggshell disinfection is described in Gottselig, Steven M., Microbial Reduction on Eggshell Surfaces by the Use of Hydrogen Peroxide and Ultraviolet Light (2011).

An important consideration for eggshell disinfection is to ensure that eggshell disinfecting agents do not alter the eggshell or penetrate into the interior of the egg. Of particular importance is the degree to which a disinfecting agent will affect a cuticle of the eggshell. The cuticle (or bloom) is a protein layer surrounding the eggshell. The cuticle acts as a barrier to prevent contaminants, such as bacteria, from entering the interior of the egg. The cuticle also regulates exchange of gases such as carbon dioxide and water vapor. Thus, any alteration of the cuticle, such as by a disinfecting agent, can change a porosity of the eggshell and adversely impact the viability of the egg.

Traditional methods of eggshell disinfection involve fumigation with formaldehyde gas. Formaldehyde has been shown to limit microbial growth on eggshell surfaces without penetrating into the interior of the egg. Formaldehyde, however, is considered to be a hazardous chemical by the U.S. Occupational Health and Safety Administration. Thus, commercial use of formaldehyde requires implementation of significant infrastructure and managerial controls to prevent human exposure to toxic fumes. In addition, quarternary ammonium compounds have been utilized is eggshell disinfection. However, quarternary ammonium, is believed to alter the cuticle of the eggshell. Altering the cuticle changes gas exchange between the egg and the environment and can be damaging to the egg.

### SUMMARY

The present application relates generally to methods and systems for sanitizing eggs and more specifically, but not by way of limitation, to methods and systems for sanitizing eggs utilizing hydrogen peroxide in combination with exposure to ultraviolet light. In one aspect, the present invention relates to a method of disinfecting an eggshell surface. In various embodiments, the method may include wetting the eggshell surface with a disinfecting agent and exposing the eggshell surface to ultraviolet light after wetting with the disinfecting agent occurs. The combination of wetting the eggshell surface with the disinfecting agent and exposing the eggshell surface to ultraviolet light reduces the number of microbes on the eggshell surface.

In another aspect, the present invention relates to an eggshell disinfecting system. In various embodiments, the system may include a spray chamber. The spray chamber may deliver a disinfecting agent to an eggshell surface. A light chamber may be arranged adjacent to the spray chamber. The light chamber may expose the eggshell surface to ultraviolet light. A conveyor may pass through the spray chamber and the light chamber.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a systematic diagram of an egg-sanitization system according to an exemplary embodiment;

FIG. 2 is a flow diagram illustrating a process utilizing the egg-sanitization system of FIG. 1;

FIG. 3 is a systematic diagram of an egg-sanitization system with secondary treatment according to an exemplary embodiment; and

FIG. 4 is a flow diagram illustrating a process for use of the egg-sanitization system of FIG. 3.

### DETAILED DESCRIPTION

Various embodiments of the present invention will now be described more fully with reference to the accompanying drawings. The invention may, however, be embodied in many different forms and should not be construed as limited to the embodiments set forth herein.

Commercial poultry operations typically include houses equipped with conveyor belts that collect eggs. Once collected on the conveyor belts, the eggs are transported to a sorting room where settable eggs are separated from unsettable eggs. In egg production for breeding, food, and vaccine purposes, the term “settable eggs” refers to eggs that are not excessively dirty, have a sound shell with no breaks or cracks, and are not excessively large or small. The eggs are arranged on incubator flats and stored in coolers until the eggs are transported to the hatchery. At the hatchery, the eggs are placed in an incubator for eighteen days after which, the eggs are transferred to a hatching cabinet. Once the eggs have hatched, the chicks are separated from the eggshells and vaccinated. It has been suggested that, for maximum effectiveness, eggs should be sanitized as close to lay as possible.

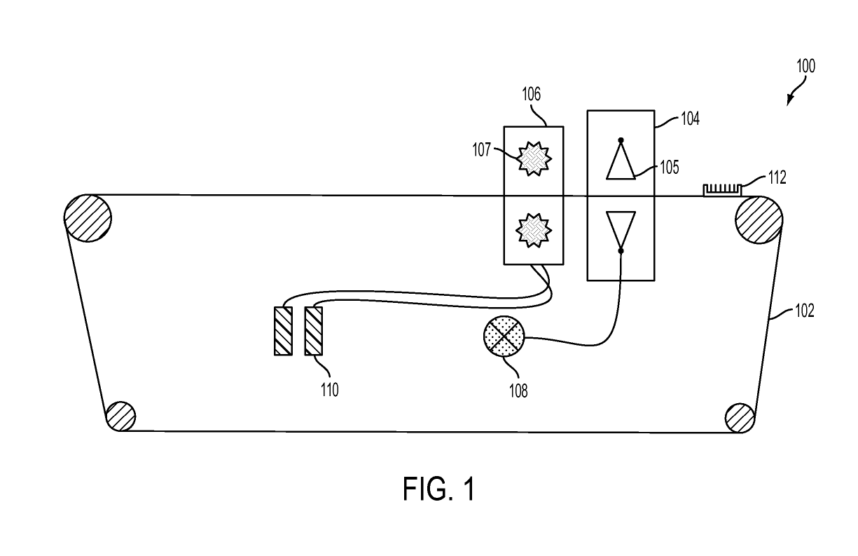

FIG. 1 is a systematic diagram of an egg-sanitization system 100. The egg-sanitization system 100 includes a spray chamber 104 arranged adjacent to a light chamber 106. A conveyor 102 is arranged to pass through the spray chamber 104 and the light chamber 106 in sequence. The spray chamber 104 includes a plurality of spray nozzles 105 arranged above and below the conveyor 102. The light chamber 106 includes a plurality of lamps 107 arranged above and below the conveyor 102. A pump 108 is fluidly coupled to the plurality of spray nozzles 105. In a typical embodiment, the pump 108 provides a liquid disinfecting agent such as, for example, hydrogen peroxide (H₂O₂) to the plurality of spray nozzles 105. In other embodiments, disinfecting agents such as, for example, peracetic acid (“PAA”) or aqueous ozone are utilized as the liquid disinfecting agent. At least one ballast 110 is electrically coupled to the plurality of lamps 107. In a typical embodiment, the at least one ballast 110 regulates an electrical current to the plurality of lamps 107. A supporter 112 is placed on the conveyor 102. In a typical embodiment, the supporter 112 is operable to hold at least one egg in an upright position. In other embodiments, the supporter 112 may be omitted. In such embodiments, the at least one egg is placed directly on the conveyor 102.

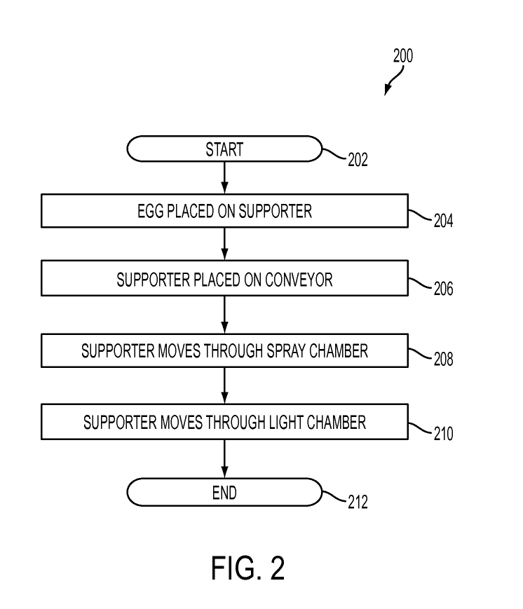

FIG. 2 is a flow diagram of a process 200 for using the egg-sanitization system 100. The process 200 begins at step 202. At step 204, at least one egg is placed into the supporter 112. At step 206, the supporter 112 is placed on the conveyor 102. At step 208, the conveyor 102 moves the supporter 112 through the spray chamber 104. In the spray chamber 104, the at least one egg is sprayed with a liquid disinfecting agent such as, for example, H₂O₂. Research has shown H₂O₂ to be an effective eggshell disinfecting agent. Lower concentrations of H₂O₂ reduce microbial levels on eggshell surfaces without alteration or damage to the cuticle. Further, H₂O₂ is safe for human skin contact. H₂O₂ is inexpensive and is readily incorporated into existing spray equipment. In other embodiments, disinfecting agents such as, for example, PAA or aqueous ozone are utilized as the liquid disinfecting agent.

Still referring to FIG. 2, at step 210, the conveyor 102 moves the supporter 112 through the light chamber 106. In the light chamber 106, the at least one egg is exposed to, for example, ultraviolet (UV) light. In a typical embodiment, the exposure to UV light lasts approximately 3 seconds or less; however, any length of exposure may be utilized. Research has shown that UV light alters genetic material within a microorganism thereby preventing the microorganism from successfully replicating. Further, UV light will not damage or otherwise alter the cuticle. UV light is environmentally friendly and does not involve the storage of hazardous chemicals. The process 200 ends at step 212. Although the process 200 is described herein as utilizing the supporter 112, one skilled in the art will recognize that, in other embodiments, the supporter 112 is omitted and the at least one egg is placed directly on the conveyor 102.

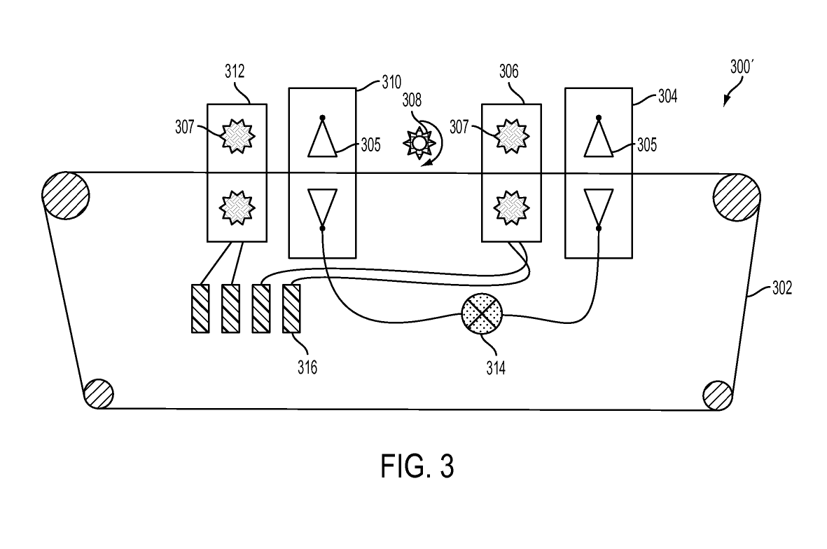

FIG. 3 is a systematic diagram of an egg-sanitization system 300 with secondary treatment. The egg-sanitization system 300 includes a first spray chamber 304 arranged adjacent to a first light chamber 306. A second spray chamber 310 is arranged adjacent to a second light chamber 312. A conveyor 302 is arranged to pass through the first spray chamber 304, the first light chamber 306, the second spray chamber 310 and the second light chamber 312 in sequence. The first spray chamber 304 and the second spray chamber 310 include a plurality of spray nozzles 305 arranged above and below the conveyor 302. The first light chamber 306 and the second light chamber 312 include a plurality of lamps 307 arranged above and below the conveyor 302. In certain embodiments, the turning device 308 is located between the first light chamber 306 and the second spray chamber 310; however, in a typical embodiment, the turning device 308 is omitted. In a typical embodiment, the turning device 308 may include, for example, rubber fingers, a brush, a belt, a foam pad and the like. A pump 314 is fluidly coupled to the plurality of spray nozzles 305. In a typical embodiment, the pump 314 provides a liquid disinfecting agent such as, for example H₂O₂, PAA, or aqueous ozone, to the plurality of spray nozzles 305. A ballast 316 is electrically coupled to the plurality of lamps 307. In a typical embodiment, the ballast 316 regulates an electrical current to the plurality of lamps 307.

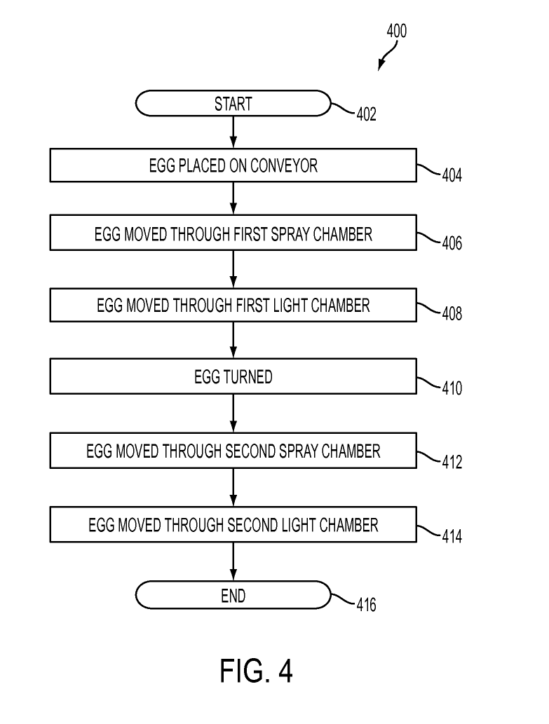

FIG. 4 is a flow diagram of a process 400 for utilizing the egg-sanitization system 300. The process 400 begins at step 402. At step 404, at least one egg is placed on the conveyor 302. In certain embodiments, the at least one egg is placed into the supporter 112 (shown in FIG. 1); however, in other embodiments, the at least one egg is placed directly on the conveyor 302. At step 406, the conveyor 302 moves the at least one egg through the first spray chamber 304. The at least one egg is sprayed with a liquid disinfecting agent such as, for example, H₂O₂, PAA, or aqueous ozone. At step 408, the conveyor 302 moves the at least one egg through the first light chamber 306. The at least one egg is exposed to, for example, UV light. In a typical embodiment, the exposure to UV light lasts approximately 3 seconds or less; however, any length of exposure may be utilized. In embodiments utilizing the turning device 308, at step 410, the at least one egg is turned, for example, approximately 180 degrees by the turning device 308. The turning device 308 rotates and contacts the at least one egg to provide sufficient resistance to allow the at least one egg to move or roll on the conveyor 302 so that a portion of the at least one egg not exposed to the first spray chamber 304 and the first light chamber 306 is exposed to the second spray chamber 310 and the second light chamber 312. At step 412, the conveyor 102 moves the at least one egg through the second spray chamber 310. In the second spray chamber 310, the at least one egg is sprayed with a liquid disinfecting agent such as, for example, H₂O₂, PAA, or aqueous ozone. At step 414, the conveyor 302 moves the at least one egg through the second light chamber 312. In the second light chamber 312, the at least one egg is exposed to, for example, UV light. In a typical embodiment, the exposure to UV light lasts approximately 3 seconds or less; however, any length of exposure may be utilized. The process 400 ends at step 416.

Application of H₂O₂ followed by exposure to ultraviolet light produces nearly instantaneous anti-microbial effects. When H₂O₂ is exposed to UV light, the UV light splits covalently bonded H₂O₂ molecule into two hydroxyl radicals. An exemplary reaction is illustrated below in Equation 1.

H₂O₂+hv→HO+HO Equation 1:

A hydroxyl radical is an example of a reactive oxygen species with a single unpaired electron. The hydroxyl radical acts to deprive other substances of an electron, which makes the hydroxyl radical a strong oxidizing agent. Research has shown that microorganisms such as, for example, gram negative anaerobes are highly sensitive to hydroxyl radicals. The oxidizing properties of the hydroxyl radical is highly effective in the destruction of microorganisms such as, for example, bacteria. It is further contemplated that application of the liquid disinfecting agent and application of UV light could be completed in approximately 10 to approximately 30 seconds. Thus, the processes 200 and 400 are rapid and highly effective. Further, the processes 200 and 400 do not leave chemical residue on the eggshell surface and do not result in human exposure to hazardous chemicals. Further, eggs treated according to the processes 200 and 400 demonstrate improved hatch rate and chick quality thus indicating that a porosity of the eggshell is not effected by the processes 200 and 400.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A method of disinfecting an eggshell surface, the method comprising:
wetting the eggshell surface with a disinfecting agent;
exposing the eggshell surface to ultraviolet light subsequent to the wetting;
wherein the wetting and the exposing reduce a number of microbes on the eggshell surface.

2. The method of claim 1, comprising placing an egg on a conveyor, the egg comprising the eggshell surface.

3. The method of claim 2, comprising moving the egg, via the conveyor, through a spray chamber and a light chamber.

4. The method of claim 1, comprising:
placing an egg into a supporter, the egg comprising the eggshell surface; and
arranging the supporter on a conveyor.

5. The method of claim 1, comprising:
re-wetting the eggshell surface with a disinfecting agent subsequent to said exposing;
re-exposing the eggshell surface to ultraviolet light subsequent to said re-wetting.

6. The method of claim 5, comprising turning an egg after the exposing, the egg comprising the eggshell surface.

7. The method of claim 1, wherein the disinfecting agent is hydrogen peroxide.

8. The method of claim 1, wherein the disinfecting agent is peracetic acid.

9. The method of claim 1, wherein the disinfecting agent is aqueous ozone.

10. The method of claim 1, wherein no chemical residue remains on the eggshell surface after the wetting and the exposing.

11. The method of claim 1, wherein the steps are performed in the order listed.

12. An eggshell disinfecting system comprising:
a first spray chamber, wherein the spray chamber delivers a disinfecting agent to an eggshell surface;
a first light chamber arranged adjacent to the spray chamber, wherein the light chamber exposes the eggshell surface to ultraviolet light; and
a conveyor passing through the spray chamber and the light chamber.

13. The system of claim 12, comprising a supporter arranged on the conveyor, the supporter supporting an egg, the egg comprising the eggshell surface.

14. The system of claim 12, further comprising:
a second spray chamber; and
a second light chamber arranged adjacent to the second spray chamber.

15. The system of claim 14, wherein the conveyor passes through the second spray chamber and the second light chamber.

16. The system of claim 14, comprising a turning device disposed between the first light chamber and the second spray chamber.

17. The system of claim 16, wherein, the conveyor passes through the turning device.

18. The system of claim 1, wherein the first spray chamber comprises a plurality of spray nozzles and the first light chamber comprises a plurality of lamps.

19. A method of disinfecting an eggshell surface, the method comprising:
placing an egg on a conveyor, the egg comprising the eggshell surface;
wetting the eggshell surface with a disinfecting agent;
exposing the eggshell surface to ultraviolet light subsequent to the wetting;
re-wetting the eggshell surface with a disinfecting agent subsequent to said exposing;
re-exposing the eggshell surface to ultraviolet light subsequent to said re-wetting; and
wherein the wetting and the exposing reduce a number of microbes on the eggshell surface.

20. The method of claim 19, comprising turning the egg between the exposing and the re-wetting.
